(19) United States
(12) Patent Application Publication
(10) Pub. No.: US 2008/0163890 A1
(43) Pub. Date: Jul. 10, 2008

(54) TUNABLE MEGASONICS CAVITATION PROCESS USING MULTIPLE TRANSDUCERS FOR CLEANING NANOMETER PARTICLES WITHOUT STRUCTURE DAMAGE

(75) Inventors: JOHN J. ROSATO, Boise, ID (US); Madhava Rao Yalamanchili, Eagle, ID (US); Victor Burton Mimken, Boise, ID (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC.

(21) Appl. No.: 11/971,412

(22) Filed: Jan. 9, 2008

Related U.S. Application Data
(60) Provisional application No. 60/884,362, filed on Jan. 10, 2007.

(51) Int. Cl. B08B 3/12

(52) U.S. Cl. 134/1

(57) ABSTRACT

A method and system for cleaning a substrate is provided. More particularly systems and methods that allows for precise tailoring of megasonics distribution at a substrate surface to be above the threshold required for particle removal efficiency (PRE), yet below the value which causes structural damage are provided. This method utilizes multiple megasonics transducers operated at very low power densities in a single substrate immersion processor. This method is shown to produce high cleaning efficiencies without damage to 45 nm devices. Further, sonoluminescence studies demonstrate that the transducers are operated in the single bubble sonoluminescence (SBSL) regime, well below the cavitation threshold for transient multiple-bubble sonoluminescence (MBSL).

### CROSS-REFERENCE TO RELATED APPLICATIONS

This application claims benefit of U.S. provisional patent application Ser. No. 60/884,362, filed Jan. 10, 2007, which is herein incorporated by reference.

### BACKGROUND OF THE INVENTION

1. Field of the Invention

Embodiments of the present invention generally relate to the field of surface preparation systems and methods. More particularly, embodiments of the present invention relate to systems and methods for cleaning substrates, including silicon substrates used in the manufacture of semiconductors.

2. Description of the Related Art

Cleaning of particles and other contaminants from semiconductor substrate surfaces is one of the critical processes in semiconductor manufacturing. Currently, metal and organic contaminants are removed from substrates using physical energies or forces in combination with various chemistries. Those physical energies include acoustic energy, such as megasonic energy, liquid or aerosol spray, and mechanical brushes.

The requirements for substrate cleaning increase as feature sizes decrease. Of particular note are the sub-angstrom film consumption requirements and the rapidly shrinking killer defect particle size which is well below 50 nm in diameter. At the core of the cleaning dilemma is the reduced efficiency of removing sub-50 nm particles. The challenge in removing these nanoparticles is that the ratio of the particle removal force to the particle adhesion force decreases dramatically with shrinking particle diameter.

In order to account for this reduced megasonics particle removal efficiency, the conventional options include increasing the megasonics power level, and/or increasing the cleaning solution concentration, cleaning time, and or temperature of the cleaning solution. Unfortunately, these options are not suitable for the more demanding sub-65 nm surface preparation requirements. Increasing the megasonic power levels introduces an excessive level of megasonics damage to the smaller geometries. Increasing the cleaning solution concentration, cleaning time, and/or temperature of the solution increases film consumption to intolerable levels.

Batch megasonics can cause extensive damage to sensitive device structures from poor control over megasonic energy distribution. Single substrate tools offer improved control, but can still exhibit isolated damage. In general, there is a linear increase in megasonics damage with increasing particle removal efficiency (“PRE”). Particle removal efficiency is defined as [[(pre-post)/pre]*100] where “pre” is the number of particles measured before cleaning and “post” is the number of particles measured after cleaning at a particle size of 90 nm or below.

While poor cleaning efficiency will have a direct effect on line yields, the damage caused to the device by cleaning-induced film loss is less obvious. This damage can include an increased isolation leakage current, a shorter effective channel length, and increased source/drain resistance.

An additional surface preparation challenge presented at the sub-65 nm node is the introduction of new materials, particularly in the device gate stack. These new materials present very stringent requirements for a native-oxide free surface without particle defects. Unfortunately, this presents an additional dilemma since the HF-last cleans which remove native oxides are notorious for leaving high particle counts, especially in batch tools.

These combined issues have proven especially challenging with the sub-65 nm technology node, and have driven the industry toward single substrate processing tools, such as the Emersion™ system described herein and available from Applied Materials, Inc. of Santa Clara, Calif., which offers the high degree of process control required. Batch tools have proven incapable of achieving high PRE without megasonics damage, watermarks, and film consumption. Furthermore, particle addition with HF-last cleans in batch tools is well above the levels that can be achieved in a single substrate tool. Single substrate cleaning tools offer more precision in terms of megasonic energy distribution, and process uniformity. Thus, there is a need for systems and methods that allow for the precise tailoring of megasonics distribution at a substrate surface to be above the threshold required for PRE, yet below the value which causes structural damage.

### SUMMARY OF THE INVENTION

Embodiments of the present invention generally relate to systems and methods for cleaning a substrate. More particularly systems and methods that allows for precise tailoring of megasonics distribution at a substrate surface to be above the threshold required for PRE, yet below the value which causes structural damage.

In one embodiment a method for cleaning a substrate is provided. A substrate comprising at least one feature definition is provided. A processing fluid is applied to the substrate. Megasonic energy is directed toward the processing fluid to produce a tunable cavitation zone. The substrate is extracted from the processing fluid through the tunable cavitation zone.

In another embodiment a method for cleaning a substrate is provided. The method comprises creating a tunable cavitation zone in the processing fluid which can be adjusted spatially with angle and power and passing a substrate through the tunable cavitation zone.

In yet another embodiment a method for cleaning a substrate is provided. A substrate comprising at least one feature definition is provided. Megasonic energy is directed toward the substrate. Controlling the megasonic energy to produce a single bubble sonoluminescence region. Extracting the substrate through the single bubble sonoluminescence region.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plot depicting device damage for 65 nm STI structures and sub-65 nm STI structures vs. Particle Removal Efficiency (PRE);

FIG. 2 is a ternary plot showing PRE response surface with various transducer configurations;

FIG. 3 is a plot depicting sonoluminescence cavitation profiles for four separate transducer configurations;

FIG. 4 is a plot depicting the effect of sonoluminescence on PRE and device damage to 65 nm poly-Si gates;

FIG. 5 is a plot depicting various cavitation profiles for a three phase megasonic interface and a two phase megasonic interface;

FIG. 6 shows a plot of both sonoluminescence and poly gate damage vs. megasonics transducer power density in accordance with one embodiment of the present invention;

FIG. 7 illustrates a cross sectional view of a substrate processing chamber in accordance with one embodiment of the present invention; and

FIG. 8 is a flow diagram depicting a method for cleaning a substrate.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

The present invention is described here with respect to a particularly preferred embodiment in which megasonics are used with a processing solution to clean silicon substrates. It will be recognized by those of ordinary skill in the art that these systems and methods can be used to practice a variety of cleaning techniques, on a variety of substrates with a variety of processing solutions. The use of the megasonics/silicon substrate example is intended to be illustrative and not limiting.

The present invention further relates to embodiments of chambers for processing a single substrate and associated processes with embodiments of the chambers. The chambers and methods of the present invention may be configured to perform substrate surface cleaning/surface preparation processes, such as etching, cleaning, rinsing and/or drying a single substrate. Although the illustrative chambers are described for use with one substrate, the embodiments described herein may be used for cleaning a plurality of substrates in a single chamber. Similar processing chambers, methods, and systems may be found in U.S. Pat. No. 6,726,848, which issued on Apr. 27, 2004, U.S. patent application Ser. No. 11/445,707, filed Jun. 2, 2006, U.S. patent application Ser. No. 11/460,172, filed Jul. 26, 2006, and U.S. patent application Ser. No. 11/620,610, filed Jan. 5, 2007, all of which are incorporated herein by reference in their entirety. Embodiments of the invention may be adapted to be disposed on a substrate surface cleaning/surface preparation tool available from Applied Materials, Inc., of Santa Clara, Calif., sold under the trade name “Emersion™.” Embodiments of the invention may also be adapted for use with other substrate surface cleaning/surface preparation tools available from other manufacturers.

Megasonic cleaning is one method of mechanical particle removal used in semiconductor substrate processing. Megasonics is derived from ultrasonic cleaning which has a wider application base and is used in many industries. Both techniques utilize cavitation as a means of particle removal. The cavitation phenomenon can be described as the bubble formation and collapse induced by pressure variations in liquids. Although it is effective for particle removal, collapsing bubbles can also cause material erosion and pattern damage.

Cavitation is generally divided into two classes—transient cavitation (a multiple bubble cavitation mechanism) and stable cavitation (a single bubble cavitation mechanism). Transient cavitation is the process where a void or bubble in a liquid rapidly collapses, producing a shockwave. In transient cavitation, a number of bubbles coalesce leading to asymmetric implosion during a positive pressure cycle. The bubbles involved in transient cavitation are characterized by a large resonance size and a short lifetime measured in nanoseconds. Transient cavitation yields a large number of photon emissions which create microjets and can damage the features on the substrate. Stable cavitation is the repeatable oscillation of bubble diameter without leading to bubble collapse. Stable cavitation is characterized by stable resonance and a long lifetime. The bubble eventually collapses leading to the emission of photons.

Through experimentation using sonoluminescence imaging, a megasonics cleaning method based on single bubble cavitation has been developed. This method utilizes multiple megasonics transducers operated at very low power densities in a single substrate immersion processor. This method is shown to produce high cleaning efficiencies without damage to 45 nm devices. Further, sonoluminescence studies demonstrate that the transducers are operated in the single bubble sonoluminescence (SBSL) regime, well below the cavitation threshold for transient multiple-bubble sonoluminescence (MBSL).

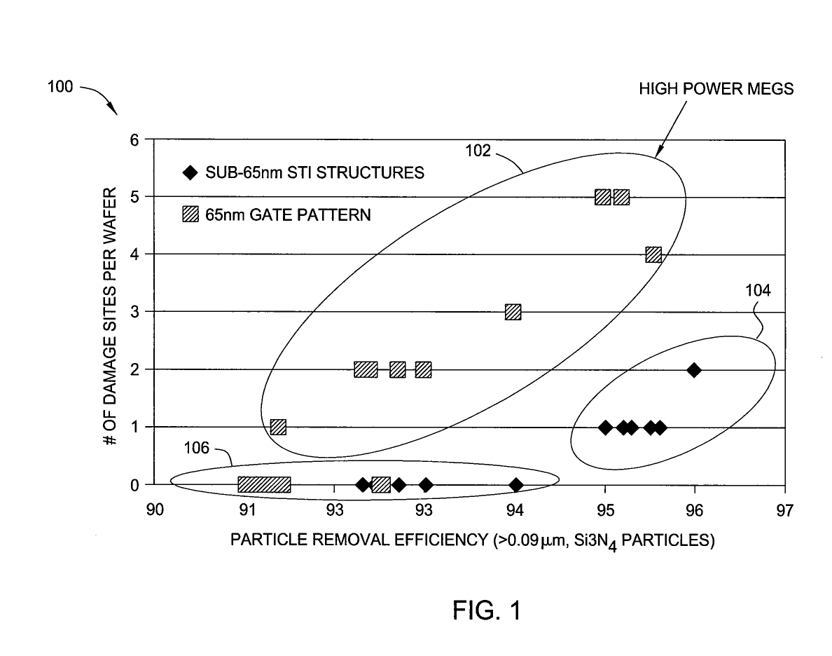

FIG. 1 is a plot 100 depicting device damage for 65 nm STI structures and sub-65 nm STI structures vs. Particle Removal Efficiency (PRE) for the system described below. The x-axis represents PRE (%) and the y-axis represents number of damage sites per wafer. Data points contained in region 102 represent the relationship between PRE and the number of damage sites in a 65 nm gate pattern for a transducer setup with high power. Data points contained in region 104 represent the relationship between PRE and the number of damage sites in a sub-65 nm STI Structure for a high power transducer setup. Data points contained in region 106 represent the relationship between PRE and the number of damage sites in sub-65 nm STI Structures and 65 nm gate patterns for a three transducer setup operating at low power. This plot 100 demonstrates that the combination of a three transducer setup with the application of low power enables damage free cleaning for both sub-65 nm STI Structures and 65 nm gate patterns. This unusual result is due to the combined interaction of the acoustic energy fields from the three transducers which creates a precisely tailored energy distribution, in terms of both amplitude and spatial distribution.

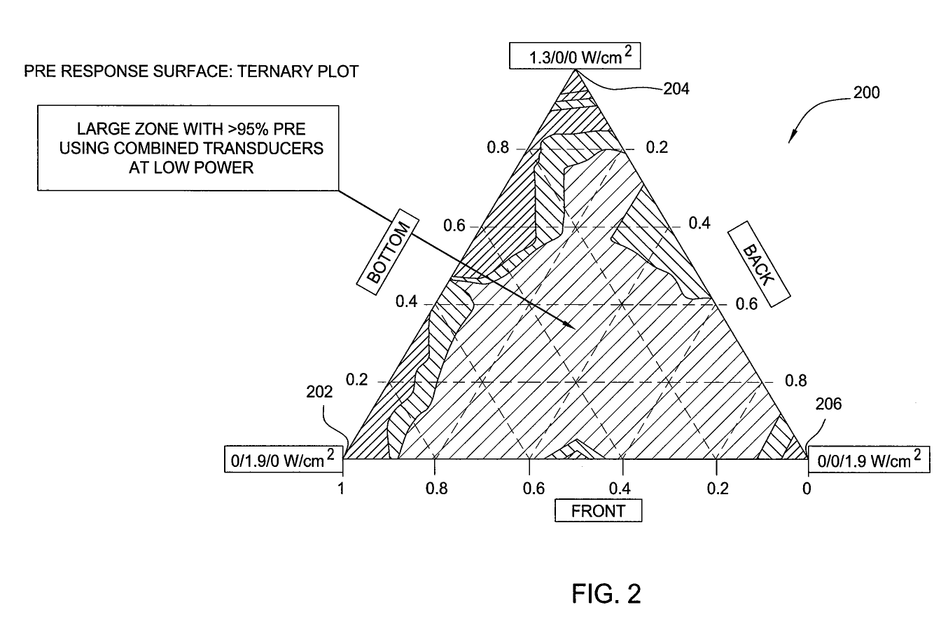

FIG. 2 is a ternary plot 200 showing the PRE response surface with various combinations of transducers. FIG. 2 summarizes the results of a full factorial design of experiments investigating the effects of both transducer configuration and power level on PRE. PRE tests were conducted using a 30 second dilute SC1 process on aged Si₃N₄ substrates deposited by wet absorption. Using the configuration (Bottom/Front/Back) in W/cm², corner 202 represents 0/1.9/0 W/cm², corner 202 represents 1.3/0/0 W/cm², and corner 206 represents 0/0/1.9 W/cm². The ternary plot 200 shows a well defined center region where high PRE values >95% are realized using the three transducers at low power. Many of the data points within this region were achieved using low megasonic power levels on the three transducer setup (e.g. <0.2 W/cm²). The PRE drops off dramatically at each apex where only a single transducer is used. Table I demonstrates the effect of megasonics configuration and total power on PRE.

TABLE I
Effect of Megasonics Configuration and Total Power on PRE.

| Configuration in W/cm² | Total Power Density | |
|---|---|---|
| (Bottom/Front/Back) | (W/cm²) | PRE (%) |
| 0/0/0.75 | 0.75 | 95 |
| 1.2/0/0 | 1.2 | 39 |
| 0.2/0.2/0.2 | 0.6 | 92 |

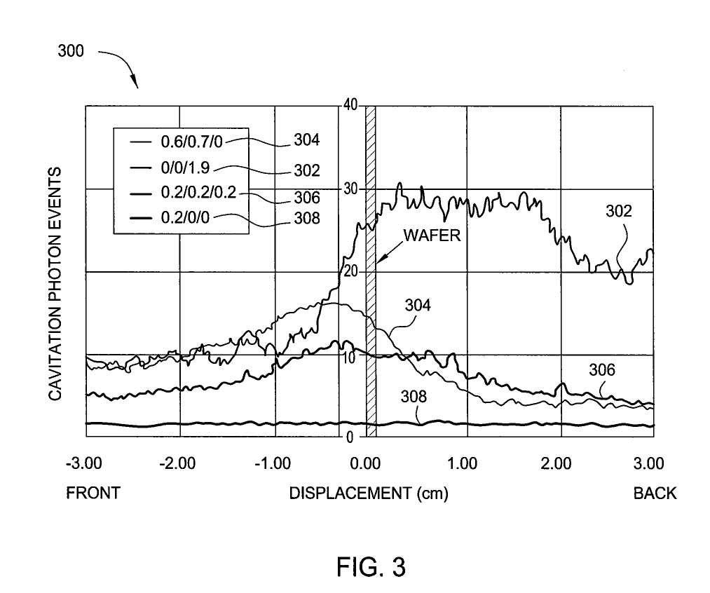

The PRE results described above suggest the presence of unusual acoustic effects within the chamber. The most likely explanation is cavitation events and possible Lamb wave generation. In order to provide a direct indication of these phenomena, sonoluminescence imaging was performed. Sonoluminescence refers to the photon emission that occurs when a collapsing cavitation bubble heats the gas within the bubble to temperatures high enough to generate incandescent lights. In these tests, an optical imaging system was mounted on top of the Emersion™ system described below to quantitatively measure sonoluminescence within the chamber. Several configurations and power levels are summarized in FIG. 3.

FIG. 3 is a plot 300 depicting sonoluminescence cavitation profiles for four separate transducer configurations. The x-axis represents distance across the chamber, while the y-axis scale represents photon emission in arbitrary units. The data shows that the cavitation events can be tailored across the chamber depending upon megasonics configuration and power density. This curve shows the photon intensity profile along the axis between the two transducers, with the substrate front surface located at x˜−0.04 cm. The notation for the power densities is “bottom/front/back.” Line 302 represents a power density of 0/0/1.9. Line 304 represents a power density of 0.6/0.7/0. Line 306 represents a power density of 0.2/0.2/0.2. Line 308 represents a power density of 0.2/0/0. Line 308 represents the bottom transducer acting alone shows very little cavitation is produced with the bottom transducer operating alone at low powers. However, Line 306 representing the low power condition with all three transducers powered at 0.2 W/cm² shows a very uniform cavitation profile. These results are summarized in Table II.

TABLE II
Effect of Megasonics Configuration & Power on
PRE, 70 nm Device Damage and Sonoluminescence.

| | | | Sonoluminescence |
|---|---|---|---|
| Configuration | | No. Damage | @ Substrate Front |
| (W/cm²) | PRE (%) | Sites | Side (arb. Units) |
| 0.6/0.7/0 | 92-98 | 0 | 14.9 |
| 0/0/1.9 | 95 | 598 | 21.7 |
| 0.2/0/0 | 24 | 139 | NA |
| 0.2/0.2/0.2 | 92 | NA | 10 |

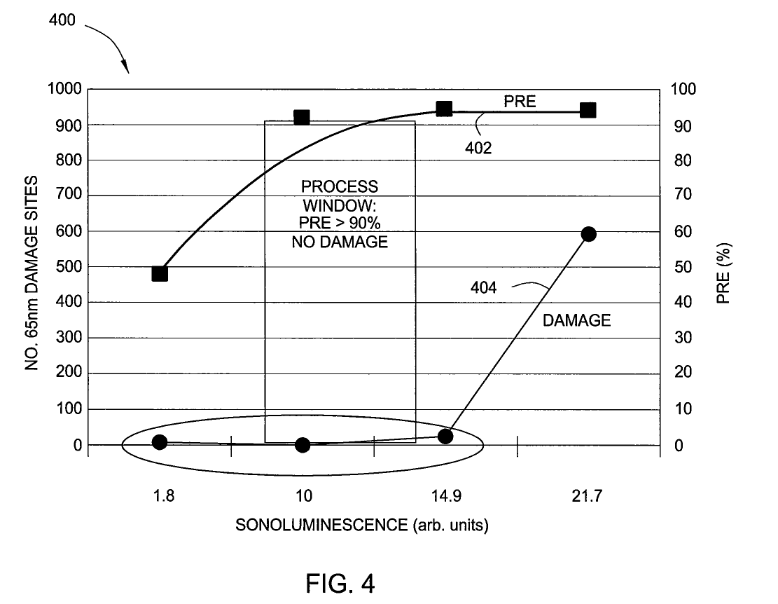

FIG. 4 is a plot 400 depicting the effect of sonoluminescence on PRE and device damage to 65 nm poly-Si gates. The x-axis represents sonoluminescence in arbitrary units, the left y-axis represents the number of 65 nm damage sites, and the right y-axis represents the PRE (%). Line 402 represents the PRE. Line 404 represents the number of damage sites. This plot 400 demonstrates that it is indeed possible to achieve the target value of >90% PRE with minimal damage to 65 nm device structures. This plot 400 further demonstrates that there is a threshold sonoluminescence value at which structure damage occurs. The plot 400 also demonstrates that the Emersion™ system PRE can reach >90% while operating below the damage threshold.

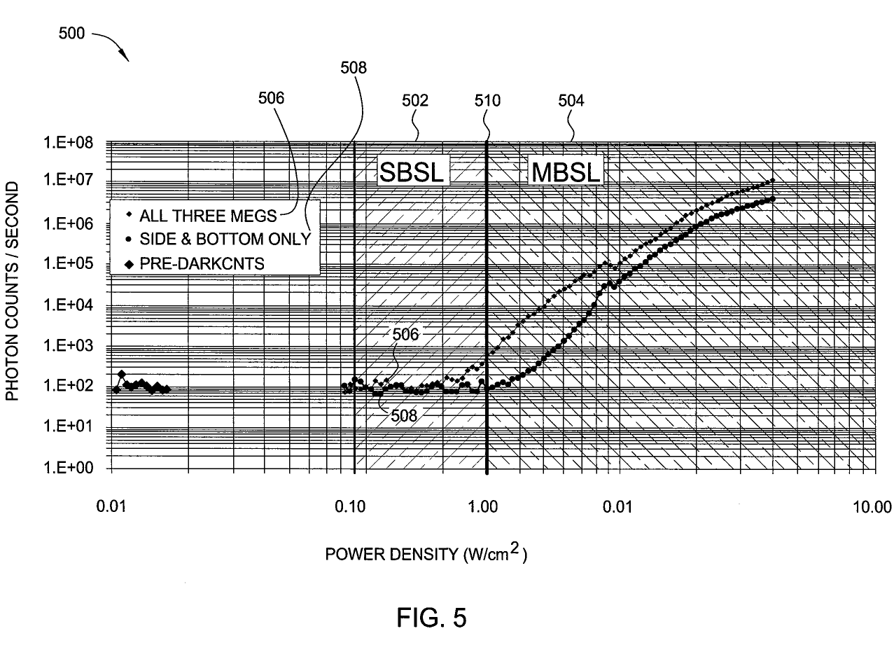

FIG. 5 is a plot 500 depicting various cavitation profiles for a three phase megasonic interface and a two phase megasonic interface. The x-axis represents power density in W/cm² and the y-axis represents photon counts/second. Region 502 represents the region where single bubble sonoluminescence occurs. Region 504 represents the region where multiple bubble sonoluminescence occurs. The data points on line 506 represents the photon count/second and power density for a system using the three megasonic setup described below. The data points on line 508 represent the photon count/second and power density for a system using the three megasonic setup described below. Line 510 represents the transient threshold between the region 502 of single bubble sonoluminescence and the region 504 of multiple bubble sonoluminescence. This plot demonstrates the ability of a multiple megasonic setup to operate at low power in region 502 of single bubble sonoluminescence below the transient threshold represented by line 510.

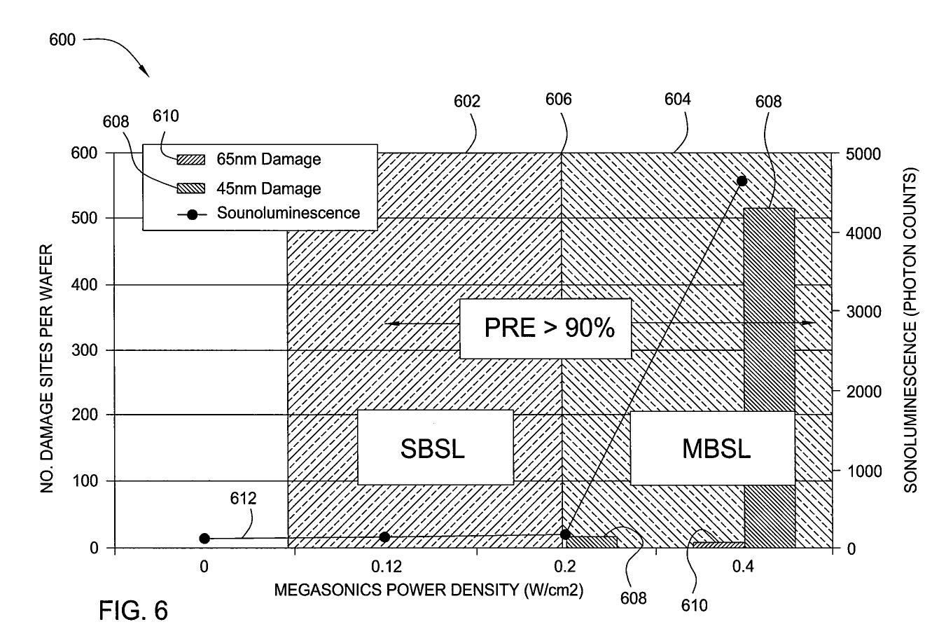

FIG. 6 shows a plot 600 of both sonoluminescence and poly gate damage for 45 nm and 65 nm structures vs. megasonics transducer power density (W/cm²). The x-axis represents megasonics power density in W/cm² and the y-axis represents the number of damage sites per wafer. Region 602 represents the region where single bubble sonoluminescence occurs. Region 604 represents the region where multiple bubble sonoluminescence occurs. Line 606 represents the transient threshold between the region 602 of single bubble sonoluminescence and the region 604 of multi bubble sonoluminescence. This data demonstrates that the damage threshold for 45 nm poly gates is lower than that for 65 nm gates. As a result, 45 nm devices must be processed with the multiple transducers operating to the left of the transient threshold where MBSL is known to begin. In spite of the low power densities, PRE values are not degraded. These results indicate that the cleaning mechanism for this technology does not rely upon the transient multiple-bubble (MB) cavitation implosions associated with conventional megasonics cleaning processes. For this low intensity case, a steady state cavitation process is induced resulting in stable, equilibrium sized bubbles. This low power megasonics system is believed to produce cleaning effects via shock waves produced by the symmetric single bubble (SB) cavitation implosions. This SB cavitation regime was previously avoided with single transducer technologies because it yielded very low PRE values. However, these results show that the cleaning can be enhanced with multiple transducers via the addition of multiple acoustic streaming phenomena, including Schlicting streaming, microstreaming and boundary layer reduction. A careful balance of the incident, reflected, and transmitted wavefronts allows for tailoring of the cavitation magnitude and location. The addition of megasonics sweeps ensures uniform exposure of the substrate to the cleaning zone. These results highlight the shrinking process window for smaller device geometries. However, these results also demonstrate that damage-free cleaning can be achieved with the use of multiple transducers to achieve precision energy control, improved control over the cavitation process, and the addition of other acoustic cleaning phenomena.

Sonoluminescence curve 612 shows the transition from single bubble sonoluminescence (SBSL) to multiple bubble sonoluminescence (MBSL) behavior. The damage curve for 45 nm poly-Si gates 608 and the damage curve for 65 nm poly-Si gates 610 show that 45 nm devices must be operated in the single bubble cavitation regime. The plot 600 also shows that high PRE values are possible in the SB regime.

A megasonics cleaning mechanism based on single bubble cavitation has been demonstrated. This method utilizes multiple megasonics transducers operated at very low power densities in a single substrate immersion processor. This method is shown to produce high cleaning efficiencies without damage to 45 nm devices. Further, sonoluminescence studies demonstrate that the transducers are operated in the single bubble sonoluminescence (SBSL) regime, well below the cavitation threshold for transient multiple-bubble sonoluminescence (MBSL).

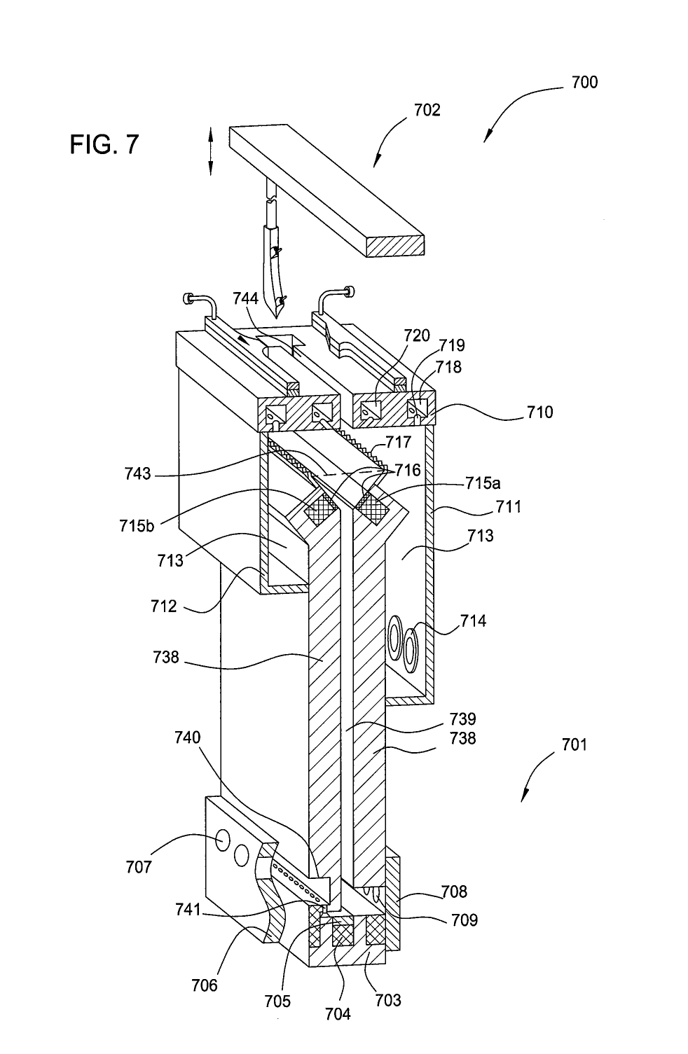

FIG. 7 illustrates a cross sectional view of a substrate processing chamber 700 which may be used with the described embodiments of the present invention. The substrate processing chamber 700 comprises a chamber body 701 configured to retain a liquid and/or a vapor processing environment and a substrate transfer assembly 702 configured to transfer a substrate in and out the chamber body 701.

The lower portion of the chamber body 701 generally comprises side walls 738 and a bottom wall 703 defining a lower processing volume 739. The lower processing volume 739 may have a rectangular shape configured to retain fluid for immersing a substrate therein. A weir 717 is formed on top of the side walls 738 to allow fluid in the lower processing volume 739 to overflow. The upper portion of the chamber body 701 comprises overflow members 711 and 712 configured to collect fluid flowing over the weir 717 from the lower processing volume 739. The upper portion of the chamber body 701 further comprises a chamber lid 710 having an opening 744 formed therein. The opening 744 is configured to allow the substrate transfer assembly 702 to transfer at least one substrate in and out the chamber body 701.

An inlet manifold 740 configured to fill the lower processing volume 739 with processing fluid is formed on the sidewall 738 near the bottom of the lower portion of the chamber body 701. The inlet manifold 740 has a plurality of apertures 741 opening to the bottom of the lower processing volume 739. An inlet assembly 706 having a plurality of inlet ports 707 is connected to the inlet manifold 740. Each of the plurality of inlet ports 707 may be connected with an independent fluid source, such as chemicals for etching, cleaning, and DI water for rinsing, such that different fluids or combination of fluids may be supplied to the lower processing volume 739 for different processes.

During processing, processing fluid may flow in from one or more of the inlet ports 707 to fill the lower processing volume 739 from bottom via the plurality of apertures 741. In one embodiment, the lower processing volume 739 may be filled in less than about 10 seconds, for example less than about 5 seconds, such as between about 5 seconds and about 1 second.

As the processing fluid fills up the lower processing volume 739 and reaches the weir 717, the processing fluid overflows from the weir 717 to an upper processing volume 713 and is connected by the overflow members 711 and 712. A plurality of outlet ports 714 configured to drain the collected fluid may be formed on the overflow member 711. The plurality of outlet ports 714 may be connected to a pump system. In one embodiment, each of the plurality of outlet ports 714 may form an independent drain path dedicated to a particular processing fluid. In one embodiment, each drain path may be routed to a negatively pressurized container to facilitate removal, draining and/or recycling of the processing fluid. In one embodiment, the overflow member 712 may be positioned higher than the overflow member 711 and fluid collected in the overflow member 712 may flow to the overflow member 711 through a conduit (not shown).

In one embodiment, a draining assembly 708 may be coupled to the sidewall 738 near the bottom of the lower processing volume 739 and in fluid communication with the lower processing volume 739. The draining assembly 708 is configured to drain the lower processing volume 739 rapidly. In one embodiment, the draining assembly 708 has a plurality of draining ports 709, each configured to form an independent draining path dedicated to a particular processing fluid. In one embodiment, each of the independent draining path may be connected to a negatively pressurized sealed container for fast draining of the processing fluid in the lower processing volume 739. Similar fluid supply and draining configuration may be found in FIGS. 9-10 of U.S. patent application Ser. No. 11/445,707, filed Jun. 2, 2006, which is incorporated herein by reference.

In one embodiment, a megasonic transducer 704 is disposed behind a window 705 in the bottom wall 703. The megasonic transducer 704 is configured to provide megasonic energy to the lower processing volume 739. The megasonic transducer 704 may comprise a single transducer or an array of multiple transducers, oriented to direct megasonic energy into the lower processing volume 739 via the window 705. When the megasonic transducer 704 directs megasonic energy into processing fluid in the lower processing volume 739, acoustic streaming, i.e. streams of micro bubbles, within the processing fluid may be induced. The acoustic streaming aids the removal of contaminants from the substrate being processed and keeps the removed particles in motion within the processing fluid hence avoiding reattachment of the removed particles to the substrate surface.

In one embodiment, a pair of megasonic transducers 715a, 715b, each of which may comprise a single transducer or an array of multiple transducers, are positioned behind windows 716 at an elevation below that of the weir 717, and are oriented to direct megasonic energy into an upper portion of lower processing region 739. The transducers 715a and 715b are configured to direct megasonic energy towards a front surface and a back surface of a substrate respectively.

The transducers 715a and 716b are preferably positioned such that the energy beam interacts with the substrate surface at or just below a gas/liquid interface (will be described below), e.g., at a level within the top 0-20% of the liquid in the lower processing volume 739. The transducers may be configured to direct megasonic energy in a direction normal to the substrate surface or at an angle from normal. Preferably, energy is directed at an angle of approximately 0-30 degrees from normal, and most preferably approximately 5-30 degrees from normal. Directing the megasonic energy from the transducers 715a and 715b at an angle from normal to the substrate surface can have several advantages. For example, directing the energy towards the substrate at an angle minimizes interference between the emitted energy and return waves of energy reflected off the substrate surface, thus allowing power transfer to the solution to be maximized. It also allows greater control over the power delivered to the solution. It has been found that when the transducers are parallel to the substrate surface, the power delivered to the solution is highly sensitive to variations in the distance between the substrate surface and the transducer. Angling the transducers 715a and 715b reduces this sensitivity and thus allows the power level to be tuned more accurately. The angled transducers are further beneficial in that their energy tends to break up the meniscus of fluid extending between the substrate and the bulk fluid (particularly when the substrate is drawn upwardly through the band of energy emitted by the transducers) thus preventing particle movement towards the substrate surface.

Additionally, directing megasonic energy at an angle to the substrate surface creates a velocity vector towards the weir 717, which helps to move particles away from the substrate and into the weir 717. For substrates having fine features, however, the angle at which the energy propagates towards the substrate front surface must be selected so as to minimize the chance that side forces imparted by the megasonic energy will damage fine structures.

It may be desirable to configure the transducers 715a and 715b to be independently adjustable in terms of angle relative to normal and/or power. For example, if angled megasonic energy is directed by the transducer 715a towards the substrate front surface, it may be desirable to have the energy from the transducer 715b propagate towards the back surface at a direction normal to the substrate surface. Doing so can prevent breakage of features on the front surface by countering the forces imparted against the front surface by the angled energy. Moreover, while a relatively lower power or no power may be desirable against the substrate front surface so as to avoid damage to fine features, a higher power may be transmitted against the back surface (at an angle or in a direction normal to the substrate). The higher power can resonate through the substrate and enhance microcavitation in the trenches on the substrate front, thereby helping to flush impurities from the trench cavities.

Additionally, providing the transducers 715a, 715b to have an adjustable angle permits the angle to be changed depending on the nature of the substrate (e.g. fine features) and also depending on the process step being carried out. For example, it may be desirable to have one or both of the transducers 715a, 715b propagate energy at an angle to the substrate during the cleaning step and then normal to the substrate surface during the drying step (see below). In some instances it may also be desirable to have a single transducer, or more than two transducers, rather than the pair of transducers 715a, 715b.

In one embodiment, the chamber lid 710 may have integrated vapor nozzles (not shown) and exhaust ports (not shown) for supplying and exhausting one or more vapor into the upper processing volume 713. During processing, the lower processing volume 739 may be filled with a processing liquid coming in from the inlet manifold 740 and the upper processing volume 713 may be filled with a vapor coming in from the vapor nozzles on the chamber lid 710. A liquid vapor interface 743 may be created in the chamber body 701. In one embodiment, the processing liquid fills up the lower processing volume 739 and overflows from the weir 717 and the liquid vapor interface 743 is located at the same level as the wire 717.

During processing, a substrate being processed in the substrate processing chamber 700 is first immersed in the processing liquid in the lower processing volume 739, and then pulled out of the processing liquid. It is desirable that the substrate is free of the processing liquid after being pulled out of the lower processing volume 739. In one embodiment, the Marangoni effect, i.e. the presence of a gradient in surface tension will naturally cause the liquid to flow away from regions of low surface tension is used to remove the processing liquid from the substrate. The gradient in surface tension is created at the liquid vapor interface 743. In one embodiment, an isopropyl alcohol (IPA) vapor is used to create the liquid vapor interface 743. When the substrate is being pulled out from the processing liquid in the lower processing volume 739, the IPA vapor condenses on the liquid meniscus extending between the substrate and the processing liquid. This results in a concentration gradient of IPA in the meniscus, and results in so-called Marangoni flow of liquid from the substrate surface.

As shown in FIG. 7, the opening 744, which is configured to allow the substrate transfer assembly 702 in and out the chamber body 701, is formed near a center portion of the chamber lid 710. The vapor nozzles are connected to a pair of inlet channels 720 formed on either side of the opening 744 in the chamber lid 710. In one embodiment, the vapor nozzles may be formed in an angle such that the vapor is delivered towards the substrate being processed. The exhaust ports 719 are connected to a pair of exhaust channels 718 formed on either side of the opening 744. Each of the exhaust channels 718 may be connected to an exhaust pipe (not shown) extending from the chamber lid 710. Other features of the substrate processing chamber are described in U.S. patent application Ser. No. 11/460,049, filed Jul. 26, 2006, which is hereby incorporate by reference in its entirety to the extent it does not conflict with the current specification.

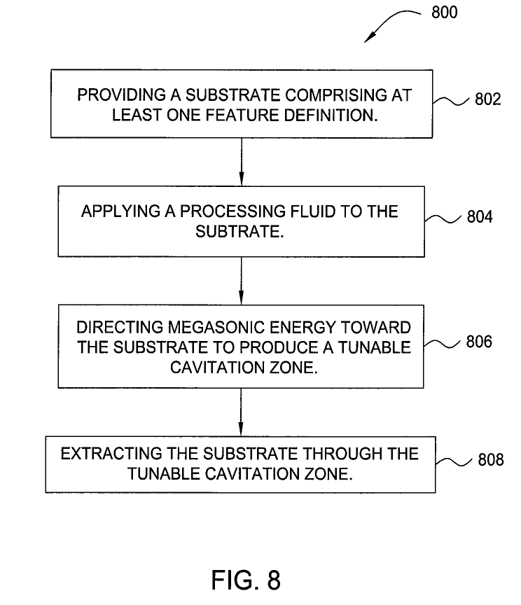

FIG. 8 is a flow diagram depicting a method 800 for cleaning a substrate. At step 802, a substrate comprising at least one feature definition is provided. At step 804, a processing fluid is applied to the substrate. At step 806, megasonic energy is directed toward the substrate to produce a tunable cavitation zone. At step 808, the substrate is extracted through the tunable cavitation zone.

Using the aforementioned data and system, a method that allows for precise tailoring of megasonics distribution at the substrate surface by achieving the threshold required for PRE, while remaining below the value that causes structural damage is provided. This method 800 may be performed in a process chamber similar to that described above with reference to FIG. 7. This method 800 may also be performed in other surface preparation systems such as batch chambers, including those available from other manufacturers. At step 802, a substrate comprising at least one feature definition is provided. In one embodiment, the feature definition is sub65 nm or less, for example, about 45 nm or less. In another embodiment, the substrate feature definition is between 45 nm and 65 nm. At step 804, a processing fluid is applied to the substrate. The processing fluid may be a cleaning solution (for example, a solution of water, NH₄OH and H₂O₂ that is known in the industry as “SC1”). Initially, the upper megasonic transducers 715a, 715b and the lower megasonic transducer 704 are powered off.

At step 806, megasonic energy is directed into the process chamber to produce a tunable cavitation zone. When the upper transducers 715a, 715b are powered on, the upper transducers form a zone Z of optimum performance. This zone Z is a band of megasonic energy extending across the chamber, preferably slightly below the gas/liquid interface. In one embodiment, the lower megasonic transducer 704 is also powered on thus contributing megasonic energy to zone Z forming a three phase interface of megasonic energy. The area of the zone Z is preferably selected such that when the substrate passes through the zone Z, up to 30 percent of the surface area of a face of the substrate is positioned within the zone. Most preferably, as the center of the substrate passes through the zone, approximately 3-30 percent of the surface area of a face of the substrate is positioned within the band.

The upper transducers 715a, 715b may be configured to direct megasonic energy in a direction normal to the substrate surface or at an angle from normal. Preferably, energy is directed at an angle of approximately 0 degrees to 30 degrees from normal, and most preferably approximately 5 degrees to 30 degrees from normal.

The tunable cavitation zone can be adjusted by modifying the power level and the angle of each transducer. As discussed above, it is preferable that the power levels be adjusted so the cleaning process can take place in the single bubble sonoluminescence region.

At step 808, the substrate is extracted through the tunable cavitation zone. A “sweep” is performed when the wafer is extracted from the chamber and inserted into the chamber through the zone Z of optimum performance. When the wafer is extracted from the chamber, the wafer is swept through this zone of optimum performance. The substrate may be translated through the zone to achieve a rate of approximately 25-300 mm/sec, such as between about 100 mm/sec and about 200 mm/sec, for example about 150 mm/sec. In one embodiment, upon initiation of the “sweep” the upper transducers and the lower transducer are powered on. The three transducers are powered to between about 0.04 W/cm² to about 0.2 W/cm² each, such as between about 0.10 W/cm² to about 0.15 W/cm², for example about 0.12 W/cm² each. In one embodiment, the three transducers are powered off after the extraction step. In one embodiment, the upper transducers 715a, 715b have different power levels. In another embodiment, the upper transducers 715a, 715b have the same power level. In another embodiment, all three transducers have different power levels. In another embodiment, all three transducers have different power levels.

Multiple embodiments utilizing principles of the present invention have been described. These embodiments are given only by way of example and are not intended to limit the scope of the claims—as the apparatus and method of the present invention may be configured and performed in many ways besides those specifically described herein. Moreover, numerous features have been described in connection with each of the described embodiments. It should be appreciated that the described features may be combined in various ways, and that features described with respect to one of the disclosed embodiments may likewise be included with the other embodiments without departing from the present invention.

While the foregoing is directed to embodiments of the present invention, other and further embodiments of the invention may be devised without departing from the basic scope thereof, and the scope thereof is determined by the claims that follow.

1. A method for cleaning a substrate, comprising:
providing a substrate comprising at least one feature definition;
applying a processing fluid to the substrate;
directing megasonic energy toward the processing fluid to produce a tunable cavitation zone; and
extracting the substrate from the processing fluid through the tunable cavitation zone.

2. The method of claim 1, wherein the tunable cavitation zone is operated in a single bubble cavitation regime.

3. The method of claim 1, wherein the at least one feature definition is about 45 nm.

4. The method of claim 1, wherein the directing megasonic energy toward the processing fluid comprises:
directing a first megasonic energy toward a bottom edge of the substrate;
directing a second megasonic energy toward a front surface of the substrate; and
directing a third megasonic energy toward a back surface of the substrate.

5. The method of claim 4, wherein the third megasonic energy is greater than the second megasonic energy.

6. The method of claim 4, wherein the second megasonic energy is greater than the third megasonic energy.

7. The method of claim 4, wherein the first megasonic energy, the second megasonic energy, and the third megasonic energy each have a power density between about 0.04 W/cm² and about 0.2 W/cm².

8. The method of claim 1, wherein the processing fluid is selected from the group comprising water, hydrogen peroxide, ammonium hydroxide, and combinations thereof.

9. The method of claim 4, wherein the first megasonic energy and the second megasonic energy are propagated at an angle that is less than normal to the surface of the substrate.

10. The method of claim 1, wherein extracting the substrate through the tunable cavitation zone further comprises moving the substrate through the zone in an edgewise direction to cause substantially the entire surface of the substrate to pass through the zone.

11. A method for cleaning a substrate, comprising:
creating a tunable cavitation zone in a processing fluid; and
passing a substrate through the tunable cavitation zone.

12. The method of claim 11, wherein the tunable cavitation zone is operated in a single bubble cavitation regime.

13. The method of claim 11, wherein the tunable cavitation zone can be adjusted by controlling a power level of the megasonic energy.

14. The method of claim 13, wherein the power level of the megasonic energy has a power density between about 0.04 W/cm² and about 0.2 W/cm².

15. The method of claim 13, wherein the power level of the megasonic energy has a power density between about 0.12 W/cm² and about 0.6 W/cm².

16. The method of claim 11, wherein the tunable cavitation zone can be controlled by adjusting the angle of the megasonic energy relative to a surface of the substrate.

17. The method of claim 16, wherein megasonic energy is propagated at an angle that is less than normal to the surface of the substrate.

18. The method of claim 11, wherein creating a tunable cavitation zone comprises:
directing a first megasonic energy toward a front surface of the substrate; and
directing a second megasonic energy toward a back surface of the substrate.

19. The method of claim 18, further comprising:
directing a third megasonic energy toward a bottom edge of the substrate.

20. The method of claim 19, wherein the power level of the each megasonic energy has a power density between about 0.04 W/cm² and about 0.2 W/cm²
